(19) United States
(12) Patent Application Publication
(10) Pub. No.: US 2013/0067346 A1
(43) Pub. Date: Mar. 14, 2013

(54) Content User Experience

(71) Applicants: Daniel Rosenstein, Issaquah, WA (US); Brian D. Remick, Snoqualmie, WA (US); Mark Sievert Larsen, Redmond, WA (US); Allison A. O'Mahony, Bellevue, WA (US); Jason M. Cahill, Woodinville, WA (US); Carmen Zlateff, Kirkland, WA (US); Francisco J. Garica-Ascanio, Redmond, WA (US); Omar Khalid, Redmond, WA (US); John M. Thornton, Kirkland, WA (US); Michael I. Torres, Seattle, WA (US); Ignatius Setiadi, Kirkland, WA (US); Chun-Kit J. Chan, Redmond, WA (US); Ronald L. Wessels, Kirkland, WA (US); Michael F. Palermiti, Issaquah, WA (US); Rachel K. Popkin, Seattle, WA (US)

(72) Inventors: Daniel Rosenstein, Issaquah, WA (US); Brian D. Remick, Snoqualmie, WA (US); Mark Sievert Larsen, Redmond, WA (US); Allison A. O'Mahony, Bellevue, WA (US); Jason M. Cahill, Woodinville, WA (US); Carmen Zlateff, Kirkland, WA (US); Francisco J. Garica-Ascanio, Redmond, WA (US); Omar Khalid, Redmond, WA (US); John M. Thornton, Kirkland, WA (US); Michael I. Torres, Seattle, WA (US); Ignatius Setiadi, Kirkland, WA (US); Chun-Kit J. Chan, Redmond, WA (US); Ronald L. Wessels, Kirkland, WA (US); Michael F. Palermiti, Issaquah, WA (US); Rachel K. Popkin, Seattle, WA (US)

(73) Assignee: Microsoft Corporation, Redmond, WA (US)

(21) Appl. No.: 13/229,554

(22) Filed: Sep. 9, 2011

(51) Int. Cl. G06F 3/00; G06F 15/16

(52) U.S. Cl. 715/741; 715/733

(57) ABSTRACT

A content user experience is described. In one or more implementations, a user interface is displayed that has selectable representations of content sources, at least one of which is available via a network. Responsive to selection of one or more of the content sources via the user interface, representations of content are displayed in the user interface using metadata obtained from the selected one or more content sources, the representations arranged according to a hierarchy used at a respective content source to arrange access to the content. Responsive to selection of one or more of the representations via the user interface; the content is obtained that corresponds to the selected representations and the obtained content is displayed in the user interface.

### BACKGROUND

Users have access to content from an ever increasing variety of sources. For example, it was typical in traditional scenarios for a user to have a single device, such as a home computer, on which the user kept photos and videos. Thus, a user could readily locate these photos or videos on that device.

However, with the expansion of network services and devices with which even a typical user may interact in a given day, the content may become scattered across these devices. For example, a user may use a dedicated camera to capture images and transfer the images to a home or work computer. The user may also use a camera included in a mobile phone to capture images and store those images on the phone. The user may also view images that are shared via a network service, such as a social network service. Thus, it may be difficult to locate desired content using traditional techniques.

### SUMMARY

A content user experience is described. In one or more implementations, a user interface is displayed that has selectable representations of content sources, at least one of which is available via a network. Responsive to selection of one or more of the content sources via the user interface, representations of content are displayed in the user interface using metadata obtained from the selected one or more content sources, the representations arranged according to a hierarchy used at a respective content source to arrange access to the content. Responsive to selection of one or more of the representations via the user interface, the content is obtained that corresponds to the selected representations and the obtained content is displayed in the user interface.

In one or more implementations, metadata is obtained, from a plurality of content sources, that describes content and how content is arranged in a hierarchy at a respective content source. An aggregate view of the plurality of content is constructed using the metadata as corresponding to the hierarchies at the respective content sources. The aggregate view is displayed in a user interface as having representations of the plurality of content accessible via the hierarchies, at least one representation being selectable to cause corresponding content to be retrieved via a network connection from a corresponding said source.

In one or more implementations, representations of images or videos are displayed in a user interface formed from metadata obtained from a plurality of content sources in which at least one content source is local to the computing device and another content source is accessible remotely to the computing device via a network. An indication is made as to which of the representations are of images or videos that have been duplicated in the plurality of content sources. One or more options are output to address the duplication of the images or videos.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to perform content user experience techniques.

FIG. 2 is an illustration of a system in an example implementation showing formation of a user experience in a user interface using metadata that describes a hierarchy of content at a content source.

FIG. 3 depicts a system in an example implementation in which communication between a consumer and a provider is shown to find and display a representation of a group of content.

FIG. 4 depicts a system in an example implementation in which communication between a consumer and a provider is shown to navigate metadata to locate content of interest.

FIG. 5 is a flow diagram depicting a procedure in an example implementation in which representations of content are arranged in a hierarchy which corresponds to a source of the content.

FIG. 6 is a flow diagram depicting a procedure in an example implementation in which an aggregate view of content is constructed from metadata obtained from a plurality of content sources.

FIG. 7 is a flow diagram depicting a procedure in an example implementation in which a user experience involving images or videos is utilized to indicate duplicates.

FIG. 8 illustrates an example system that includes the computing device as described with reference to FIG. 1.

FIG. 9 illustrates various components of an example device that can be implemented as any type of computing device as described with reference to FIGS. 1, 2, and 6 to implement embodiments of the techniques described herein.

### DETAILED DESCRIPTION

### Overview

A content user experience is described in the following that may be used to browse, view, search and sort content such as photos and videos from remote devices associated a user account, which may include devices that are particular to a user as well as devices that are part of a network service, such as a social network. In this way, a user may interact with content that is local to a device as well as content that is associated with the user from other devices or services and may be cached locally on the device to provide a variety of different scenarios, such as offline access.

This may support a variety of other functionality, including an ability to aggregate content across devices and services of a user. For example, a user may wish to locate a photo from a particular year. Using these techniques, a user interface may be output via which the user may navigate through photos and videos from each of the user's devices by date, regardless of where the photo is stored. Further, these techniques may leverage metadata such that the user may navigate through representations of the content to locate content of interest without involving a download of each of the content items to local storage. A variety of other techniques are also contemplated, further discussion of which may be found in relation to the following sections.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

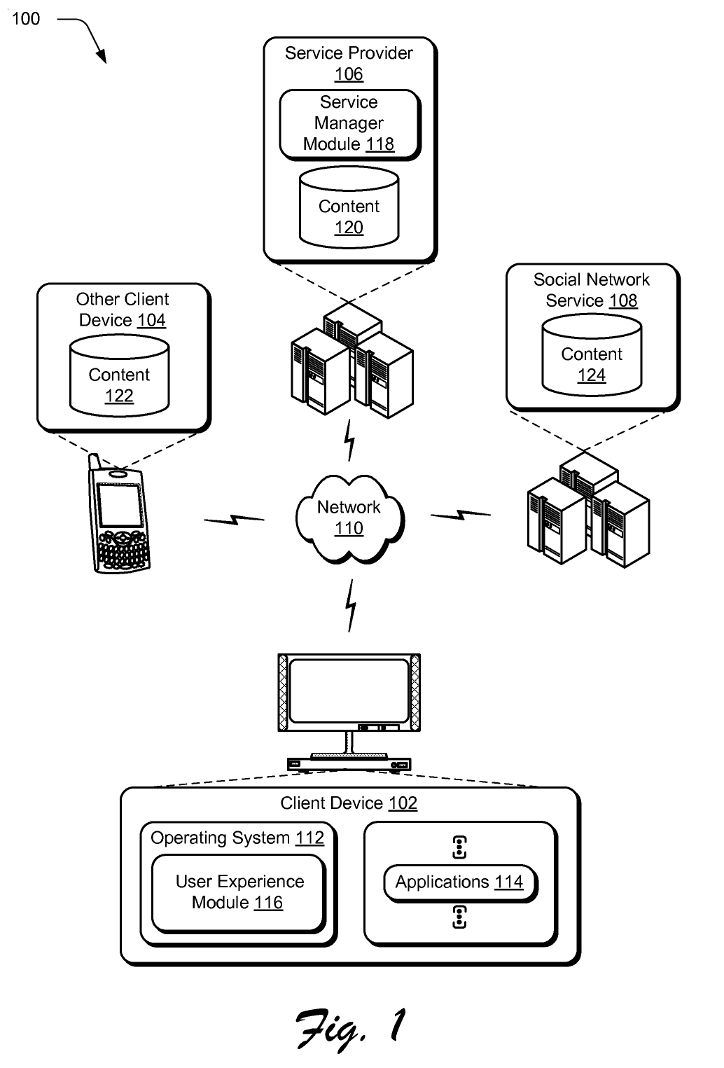

FIG. 1 is an illustration of an environment 100 in an example implementation that is operable to employ techniques described herein. The illustrated environment 100 includes a client device 102, another client device 104, a service provider 106, and a social network service 108 that are communicatively coupled via a network 110. The client device 102, other client device 104, service provider 106, and social network service 108 may be implemented by one or more computing devices and also may be representative of one or more entities.

A computing device may be configured in a variety of ways. For example, a computing device may be configured as a computer that is capable of communicating over the network 110, such as a desktop computer, a mobile station, an entertainment appliance, a set-top box communicatively coupled to a display device, a wireless phone, a game console, and so forth. Thus, the computing device may range from full resource devices with substantial memory and processor resources (e.g., personal computers, game consoles) to a low-resource device with limited memory and/or processing resources (e.g., traditional set-top boxes, hand-held game consoles). Additionally, although a single computing device is shown in some instances, the computing device may be representative of a plurality of different devices, such as multiple servers utilized by a business to perform operations such as by the service provider 106 and/or social network service 108, and so on.

Although the network 110 is illustrated as the Internet, the network may assume a wide variety of configurations. For example, the network 110 may include a wide area network (WAN), a local area network (LAN), a wireless network, a public telephone network, an intranet, and so on. Further, although a single network 110 is shown, the network 110 may be configured to include multiple networks.

The client device 102 is further illustrated as including an operating system 112. The operating system 112 is configured to abstract underlying functionality of the underlying device to applications 114 that are executable on the client device 102. For example, the operating system 112 may abstract processing, memory, network, and/or display functionality such that the applications 114 may be written without knowing “how” this underlying functionality is implemented. The application 114, for instance, may provide data to the operating system 112 to be rendered and displayed by a display device as illustrated without understanding how this rendering will be performed.

The operating system 112 is also illustrated as including a user experience module 116. The user experience module 116 is representative of functionality to generate and output a user interface for display by the display device or other output device of the client device 102, e.g., speakers. The user interface may be configured to support a wide variety of functionality.

For example, the user experience module 116 may be configured to support an integrated content user experience via which a user may search, browser, view, and sort content. This functionality may be implemented solely by the user experience module 116 or in combination with other entities, such as in combination with the service provider 106.

The service provider 106 is illustrated as including a service manager module 118. The service manager module 118 may be representative of functionality to provide network services that are accessible via the network, such as to manage content 120. One such network service may be configured as a file hosting service such that a user and/or application 114 may specify files, libraries, and so on to be synchronized between the network service and specified devices that may be associated with a user account of the network service.

A user of client device 102, for instance, may interact with a user interface output by the user experience module 116. Via this interaction, the user may specify which devices of the user are to synchronize content, such as by specifying that content 122 of the other client device 104 and client device 102 are to be synchronized with content 120 of the service provider 106. Thus, in this example the client device 102, the other client device 104, and the service provider 106 each include local copies of content that match.

The service manager module 118 may also support a network service to act as a repository for content 120 without synchronization. Thus, in this example, different items of content may be stored by the service provider 106, the client device 102, as well as the other client device 104.

The service manage module 118 may also support a network service to interact with other network services via a network 110. The service manager module 118, for instance, may use logon credentials (e.g., user name and password) to access content 124 associated with a user's account of a social network service 108. This functionality may be utilized to interact with other network services, such as to provide an aggregate view of content from these services such as status updates, view photo albums and videos, and so on. The functionality described above may also be incorporated whole or in part by the user experience module 116.

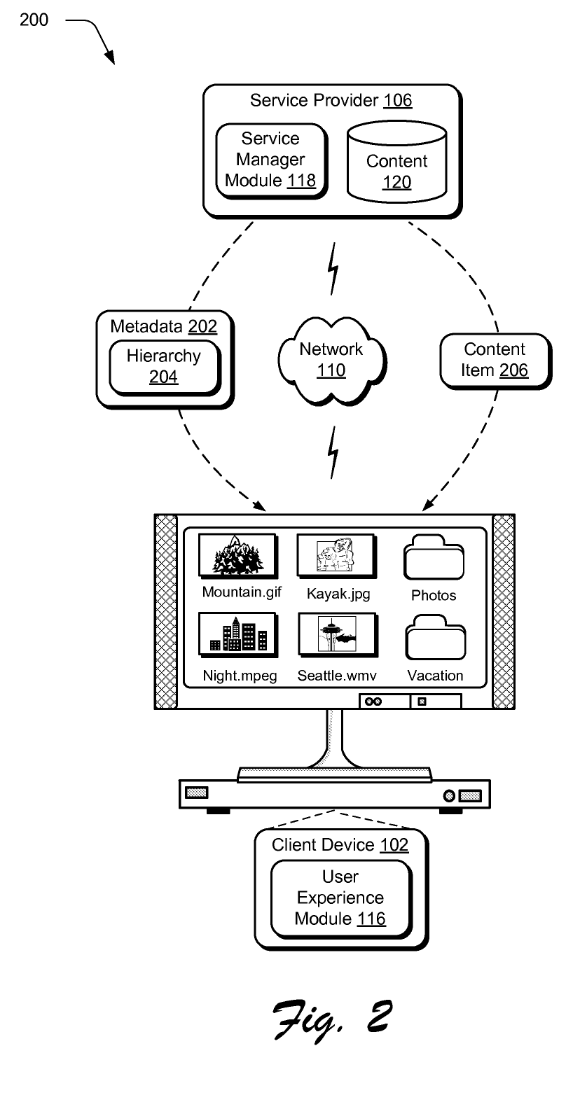

The user experience module 116 may leverage these techniques to provide a user interface via which a user may navigate through the content from these different sources. Additionally, the user experience module 116 may configure this navigation to mimic a structure of how the content is arranged via the respective source. In this way, a user may be given a familiar experience with which to locate content of interest, further discussion of which may be found in relation to FIG. 2.

Generally, any of the functions described herein can be implemented using software, firmware, hardware (e.g., fixed logic circuitry), or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices. The features of the techniques described below are platform-independent, meaning that the techniques may be implemented on a variety of commercial computing platforms having a variety of processors.

For example, the computing device 102 may also include an entity (e.g., software) that causes hardware of the computing device 102 to perform operations, e.g., processors, functional blocks, and so on. For example, the computing device 102 may include a computer-readable medium that may be configured to maintain instructions that cause the computing device, and more particularly hardware of the computing device 102 to perform operations. Thus, the instructions function to configure the hardware to perform the operations and in this way result in transformation of the hardware to perform functions. The instructions may be provided by the computer-readable medium to the computing device 102 through a variety of different configurations.

One such configuration of a computer-readable medium is signal bearing medium and thus is configured to transmit the instructions (e.g., as a carrier wave) to the hardware of the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

FIG. 2 is an illustration of a system 200 in an example implementation showing formation of a user experience in a user interface using metadata that describes a hierarchy of content at a content source. In this example, a user experience module 116 of the client device 102 is illustrated as being in communication with the service manager module 118 of the service provider 106 via a network 110.

The client device 102 in this instance receives metadata 202 which includes data that describes a hierarchy 204 in which the content 120 is arranged at the service provider 106 and/or other devices or services via which the service provider 106 has access to content as described in FIG. 1. For example, the hierarchy 204 may specify an arrangement of items and folders as illustrated in the user interface shown on the display device of the client device 102 in FIG. 2. This arrangement may mimic the arrangement of the items as found at a source of the content 120, e.g., the service provider 106, other client device 104, social network service 108, and so on. Thus, a familiar hierarchical arrangement may be navigated by a user that has similar groupings and levels of content.

The user experience module 116 may also employ one or more techniques to support efficiency of interaction between the client device 102 and sources of the content. For example, the user experience module 116 may be configured to form representations of content from the metadata 202 for display by the client device 102 without actually downloading the content 120 to local storage on the client device. Therefore, a user may navigate through the representations of content to locate a particular item of interest.

In one or more implementations, the metadata 202 is obtained dynamically by the user experience module 116 responsive to navigation through the representations to populate the user interface. For example, responsive to a user selection of the “vacation” folder metadata that describes content included in that folder may be fetched by the user experience module 116 from the service provider 106. Pre-fetching techniques may also be employed such that metadata that corresponds to likely subsequent points in navigation may be obtained before selection by a user, e.g., the representations of content items in the “photos” folder may be pre-fetched when the folder comes into view in the user interface.

Representative portions of the content may also be collected. For example, the user experience module 116 and/or the service manager module 118 may determine which item of content is representative of the content as a whole, e.g., a frame in a video, a photo from a photo library, and so on. Metadata relating to this item may then be used to represent that content, e.g., as an icon for a photo library, a video, and so forth.

The user experience module 116 may also support different views and therefore fetch corresponding data. The user experience module 116, for instance, may output thumbnails as representations of content 120. If an input is received from the user indicating that a change is to be made to a different view, e.g., large icons, additional data may be obtained from the service provider 106 dynamically to generate the different view, such as to enlarge the representations. In an instance in which the switch in views is to cause smaller representations to be shown (e.g., from large icons to thumbnails), the representations may be processed locally at the client device 102 without communicating with the service provider 106, thereby conserving network 110 and service provider 106 resources.

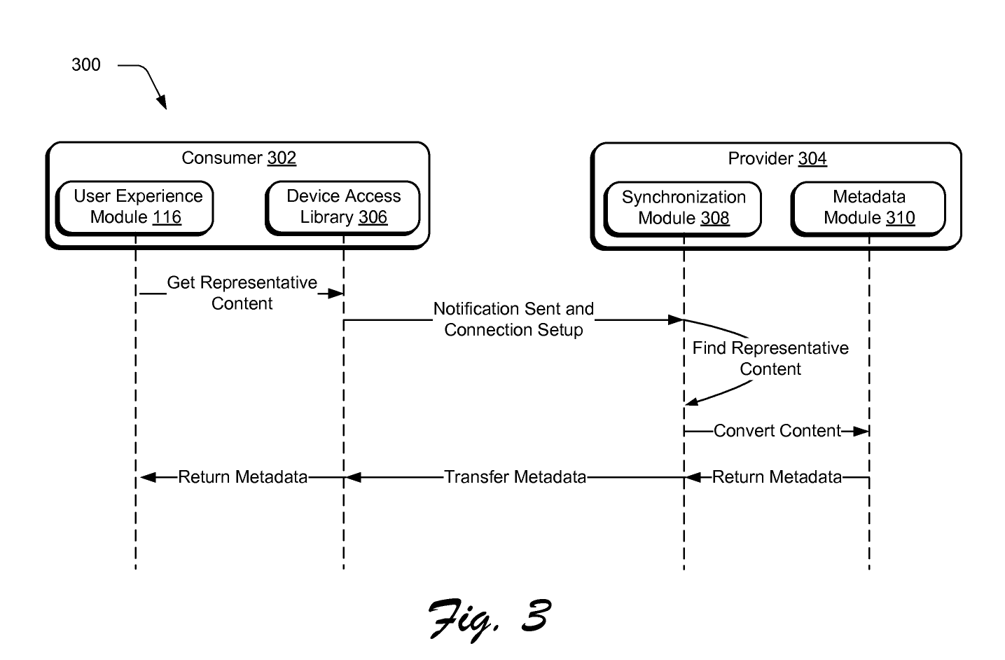

FIG. 3 depicts a system 300 in an example implementation in which communication between a consumer and a provider is shown to find and display a representation of a group of content. The illustrated system 300 includes a consumer 302 and a provider 304 which, as the names indicate, specify entities that consume and originate content for consumption, respectively, such as the client device 102 and service provider 104 of FIGS. 1 and 2. It should be readily apparent, though, that the service provider 104 may also be configured to consume content from the client device 102, e.g., to obtain content stored locally at the client device 102.

The consumer 302 is illustrated as including a user experience module 116 and a device access library 306 and the provider 304 is illustrated as including a synchronization module 308 and a metadata module 310. This system 300 is configured to synchronize content between devices and services as previously described, such as to support synchronization, interaction with other network services, and so on.

The device access library 306 may be configured as part of a client access library to enumerate endpoints that may be access by the user experience module 116, such as the other client device 104, the service provider 106, a network service such as the social network service 108, and so on. In one or more implementations, the device access library 306 may be implemented to be content type specific, such as to expose photos or videos sources solely, although other implementations are also contemplated.

A user may launch a user experience through interaction with a user experience module to view content from one or more sources. The user experience, for instance, may configure a user interface to include representations of content sources, such as the other client device 104, storage of the service provider 106, a network service such as the social network service 108, and so on.

In one or more implementations, the content source, groups of content, and even a single item of content may be represented by a portion of that content. For example, a video may be represented by a frame taken from the video, a photo album may be represented by one of the photos contained in the album, and so on.

Accordingly, to obtain this representation the user experience module 116 communicates a request to the device access library 306. The device access library 306 then sets up a network connection and sends a notification to request the representative content to the provider 304.

A synchronization module 308 of the provider 304 finds the representative content and communicates the content to a metadata module 310. The metadata module 310 may then convert the content into metadata, that is passed back to the synchronization module 308, through the device access library 306, and then to the user experience module 116 for display in a user interface. The representative content, for instance, may be used to represent a content source, a collection of content, a single item of content, and so on. Other communications are also contemplated, further discussion of which may be found in relation to the following figure.

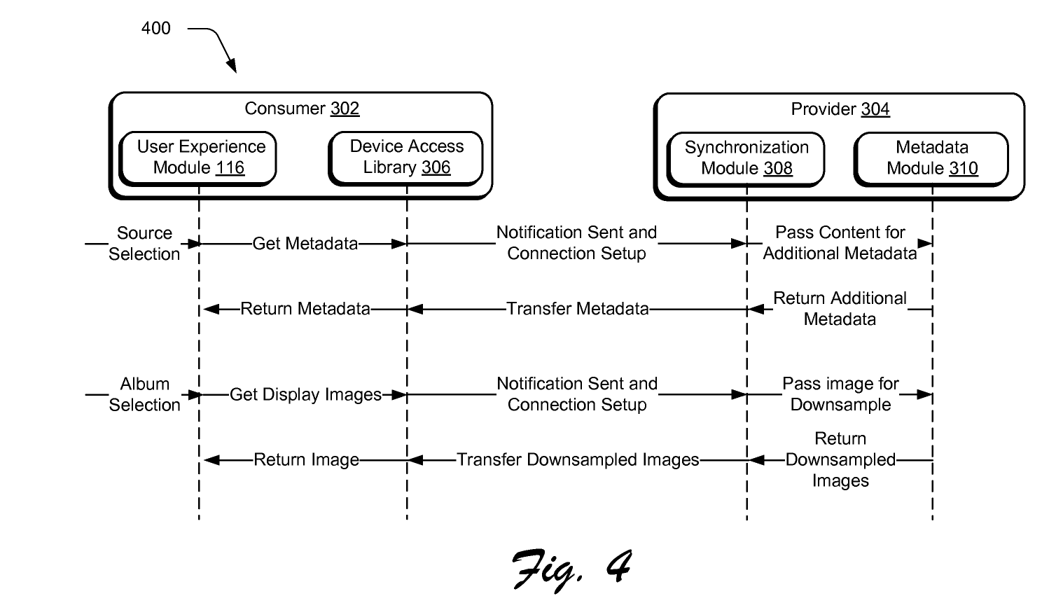

FIG. 4 depicts a system 400 in an example implementation in which communication between a consumer and a provider is shown to navigate metadata to locate content of interest. A user interface may be output by the user experience module 116 via which a user may select a source of content. In response, the user experience module 116 may form a request for metadata that is sent using the device access library 306 for receipt by the provider 304.

The synchronization module 308 in this instance may pass the content to the metadata module 310 to generate additional metadata that describes the content and/or an arrangement of the content, e.g., the hierarchy 204 of FIG. 2. The metadata module 310 may then pass the additional metadata back to the synchronization module 308, through the device access library 306, and then to the user experience module 116 for display in a user interface.

As illustrated, similar techniques may also be used to fetch representations of images in a photo album. In the illustrated example, down-sampled images (e.g., thumbnails) are used to represent the images and are returned for output by the consumer 302. Selection of the thumbnails may cause the user experience module 116 to obtain the represented content, e.g., the image in its original form. These techniques may also be employed for video, such as to transfer a representative image, a portion of the video, and so on. Thus, the consumer and the provider 304 may efficiently communicate over the network 112. Although images and video were described for these examples, it should be readily apparent that a variety of different types of content may also leverage these techniques without departing from the spirit and scope thereof as previously described in relation to FIG. 1. Additionally, it should be apparent that both device and services may employ these techniques, such as to create network messages requests from a client access library instead of a device access library and send these to the service.

Example Procedures

The following discussion describes content user experience techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the systems 200, 300, 400 of FIGS. 2-4, respectively.

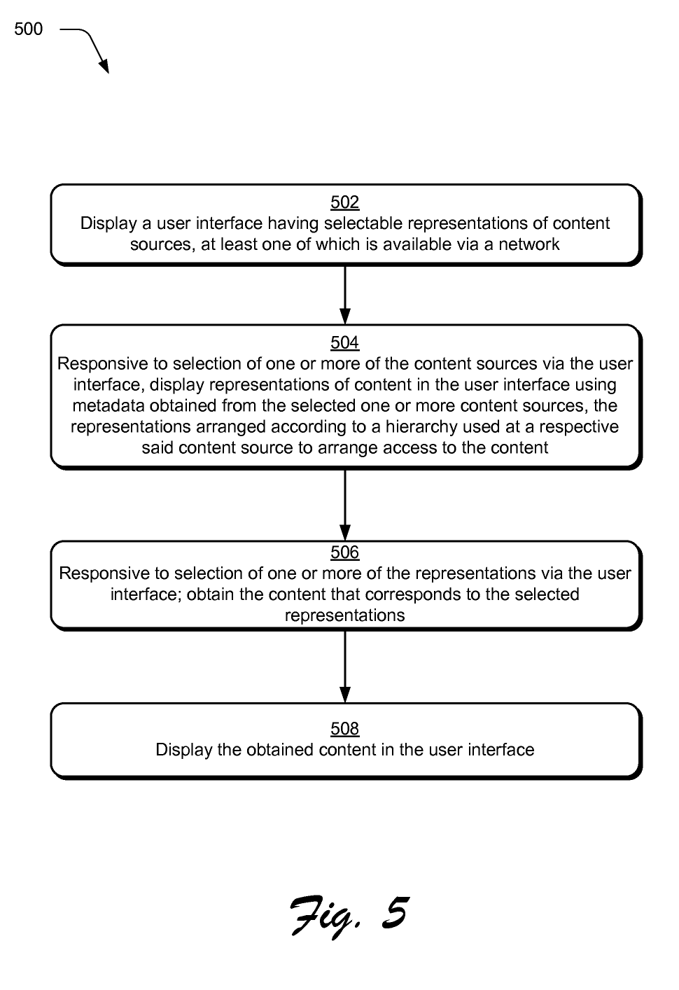

FIG. 5 depicts a procedure 500 in an example implementation in which representations of content are arranged in a hierarchy which corresponds to a source of the content. A user interface is displayed that has selectable representations of content sources, at least one of which is available via a network (block 502). The representations, for instance, may represent a content source that is local to the client device 102, content that is available via the other client device 104 that is associated with the client device 102 (e.g., via synchronization, granting of access rights, and so on), via a network service such as the social network service 108, and so on. These representations may be formed in a variety of ways, such as text, icons, tiles, include use of representative content, and so forth.

Responsive to selection of one or more of the content sources via the user interface, representations of content are displayed in the user interface using metadata obtained from the selected one or more content sources, the representations arranged according to a hierarchy used at a respective content source to arrange access to the content (block 504). The representations, for instance, may be arranged according a hierarchy (e.g., folder, sub-folders, grouping, and order) that mimics how the content is made available directly from a source of the content.

Responsive to selection of one or more of the representations via the user interface, the content is obtained that corresponds to the selected representations (block 506) and the obtained content is displayed in the user interface (block 508). Thus, as previously described in relation to FIG. 2 the metadata may be used to efficiently transfer data sufficient to locate an item of interest without transferring an entirety of an item. The item may be located in a variety of ways, such as by performing a search (e.g., using one or more keywords), manual navigation through the hierarchy, and so on.

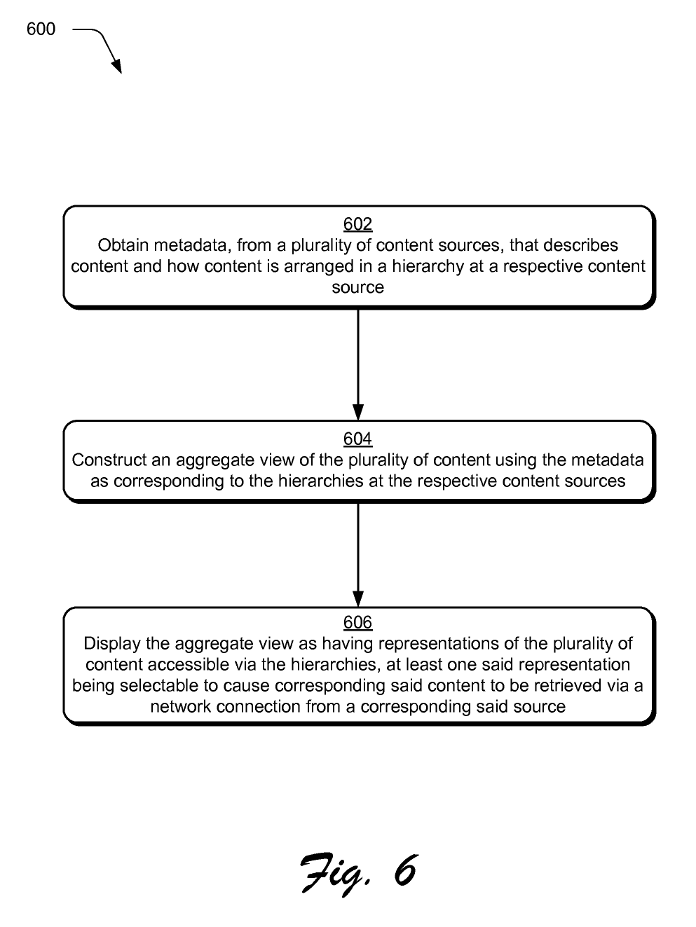

FIG. 6 depicts a procedure 600 in an example implementation in which an aggregate view of content is constructed from metadata obtained from a plurality of content sources. Metadata is obtained, from a plurality of content sources, which describes content and how content is arranged in a hierarchy at a respective said content source (block 602). As before, the metadata 202 may describe the content 120, such as a name, date modified, type, user access, author, include a portion of the content that is representative of the content, and so on. The metadata 202 may also specify a hierarchy 204 to indicate how the content is arranged in relation to each other.

An aggregate view of the plurality of content is constructed using the metadata as corresponding to the hierarchies at the respective said content sources (block 604). The aggregate view is displayed in a user interface as having representations of the plurality of content accessible via the hierarchies, at least one representation being selectable to cause corresponding content to be retrieved via a network connection from a corresponding source (block 606). The aggregate view, for instance, may include hierarchies from different content sources. A user may then navigate through the hierarchies as previously described to locate content of interest and cause that content to be retrieved for local storage at a device that outputs the user interface, e.g., the client device 102.

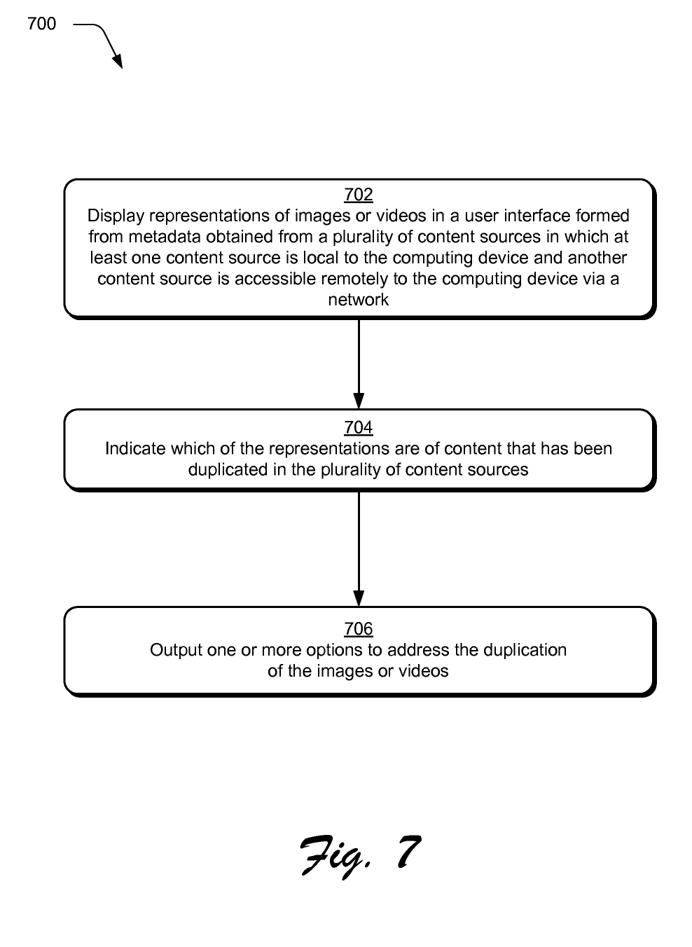

FIG. 7 depicts a procedure 700 in an example implementation in which a user experience involving images or videos is utilized to indicate duplicates. Representations of images or videos are displayed in a user interface formed from metadata obtained from a plurality of content sources in which at least one content source is local to the computing device and another content source is accessible remotely to the computing device via a network (block 702). As before, these representations may be generated in a variety of ways and configured to provide a variety of information that describes the represented content.

An indication is made as to which of the representations are of images or videos that have been duplicated in the plurality of content sources (block 704). A user interface, for example, may provide a graphical indication (e.g., highlighting, shadow, grayscale, animations), text, and so on that indicates that an item of content is duplicated in the content sources. This may include duplication of an item on a single content source, duplication across content sources, and so on.

One or more options are output to address the duplication of the images or videos (block 706). The option, for instance, may be user selectable to cause a particular one of the duplicates to be deleted, may identify from which content source the duplicates are available, and so on. In this way, knowledge of the user experience module 116 of the different content sources may be leveraged to address which content is included in those sources and provide an “overall” view of the content.

Example System and Device

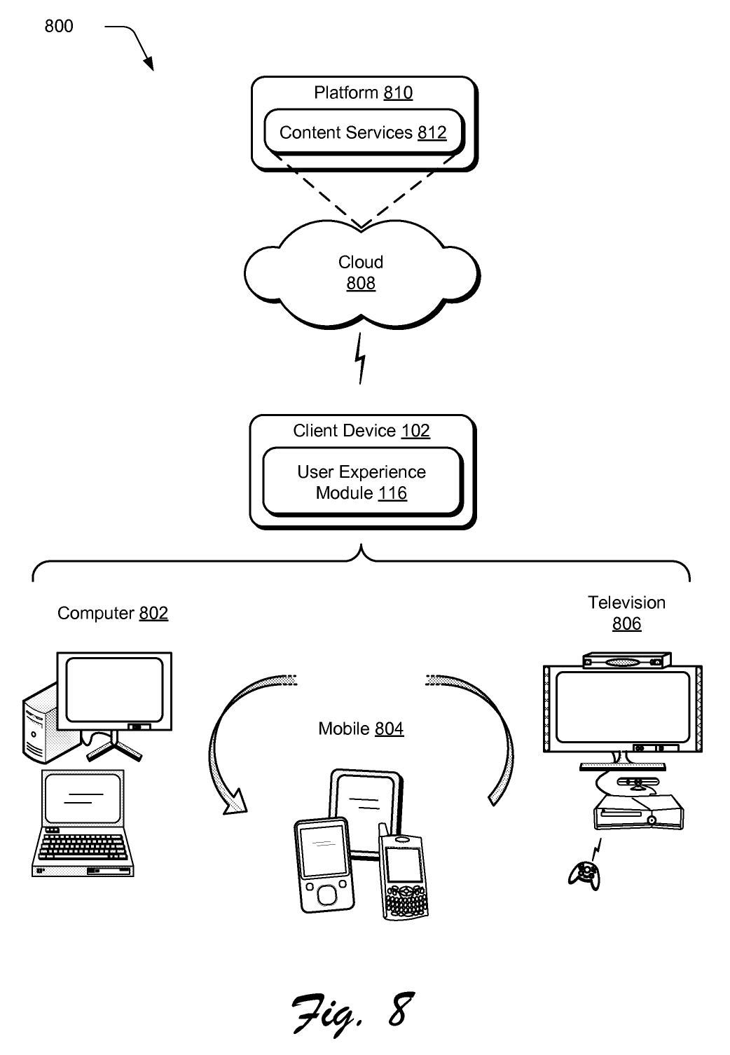

FIG. 8 illustrates an example system 800 that includes the computing device 102 as described with reference to FIG. 1. The example system 800 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 800, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link. In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 102 may assume a variety of different configurations, such as for computer 802, mobile 804, and television 806 uses. Each of these configurations includes devices that may have generally different constructs and capabilities, and thus the computing device 102 may be configured according to one or more of the different device classes. For instance, the computing device 102 may be implemented as the computer 802 class of a device that includes a personal computer, desktop computer, a multi-screen computer, laptop computer, netbook, and so on.

The computing device 102 may also be implemented as the mobile 804 class of device that includes mobile devices, such as a mobile phone, portable music player, portable gaming device, a tablet computer, a multi-screen computer, and so on. The computing device 102 may also be implemented as the television 806 class of device that includes devices having or connected to generally larger screens in casual viewing environments. These devices include televisions, set-top boxes, gaming consoles, and so on. The techniques described herein may be supported by these various configurations of the computing device 102 and are not limited to the specific examples the techniques described herein. This is illustrated through inclusion of the user experience module 116 on the client device 102, although it should be readily apparent that this functionality may be further distributed through the system, such as leverage content services 812 of the platform 810.

The cloud 808 includes and/or is representative of a platform 810 for content services 812. The platform 810 abstracts underlying functionality of hardware (e.g., servers) and software resources of the cloud 808. The content services 812 may include applications and/or data that can be utilized while computer processing is executed on servers that are remote from the computing device 102. Content services 812 can be provided as a service over the Internet and/or through a subscriber network, such as a cellular or Wi-Fi network.

The platform 810 may abstract resources and functions to connect the computing device 102 with other computing devices. The platform 810 may also serve to abstract scaling of resources to provide a corresponding level of scale to encountered demand for the content services 812 that are implemented via the platform 810. Accordingly, in an interconnected device embodiment, implementation of functionality of the functionality described herein may be distributed throughout the system 800. For example, the functionality may be implemented in part on the computing device 102 as well as via the platform 810 that abstracts the functionality of the cloud 808.

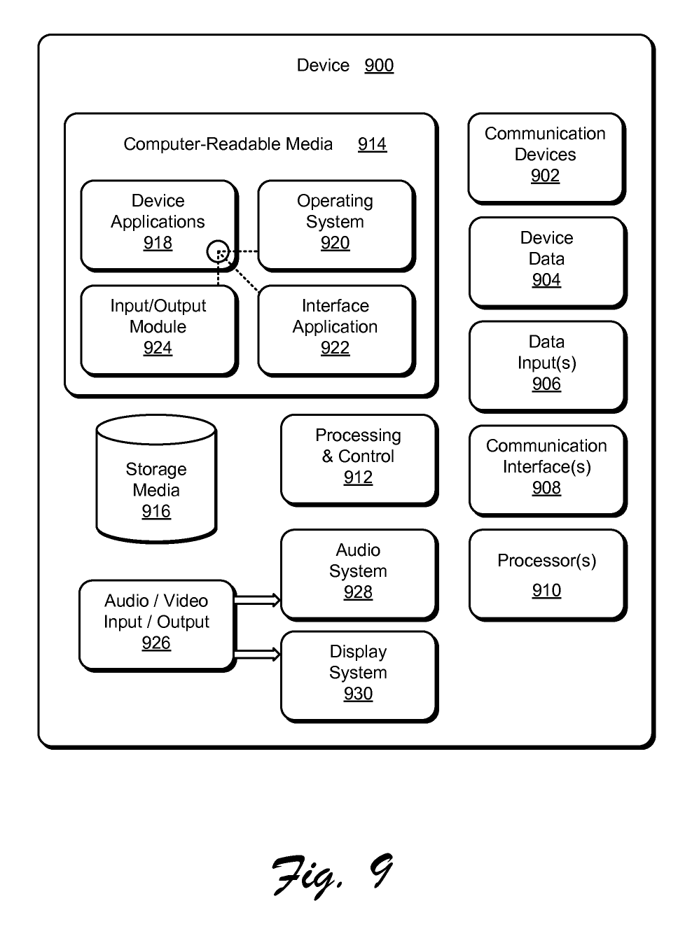

FIG. 9 illustrates various components of an example device 900 that can be implemented as any type of computing device as described with reference to FIGS. 1, 2, and 8 to implement embodiments of the techniques described herein. Device 900 includes communication devices 902 that enable wired and/or wireless communication of device data 904 (e.g., received data, data that is being received, data scheduled for broadcast, data packets of the data, etc.). The device data 904 or other device content can include configuration settings of the device, media content stored on the device, and/or information associated with a user of the device. Media content stored on device 900 can include any type of audio, video, and/or image data. Device 900 includes one or more data inputs 906 via which any type of data, media content, and/or inputs can be received, such as user-selectable inputs, messages, music, television media content, recorded video content, and any other type of audio, video, and/or image data received from any content and/or data source.

Device 900 also includes communication interfaces 908 that can be implemented as any one or more of a serial and/or parallel interface, a wireless interface, any type of network interface, a modem, and as any other type of communication interface. The communication interfaces 908 provide a connection and/or communication links between device 900 and a communication network by which other electronic, computing, and communication devices communicate data with device 900.

Device 900 includes one or more processors 910 (e.g., any of microprocessors, controllers, and the like) which process various computer-executable instructions to control the operation of device 900 and to implement embodiments of the techniques described herein. Alternatively or in addition, device 900 can be implemented with any one or combination of hardware, firmware, or fixed logic circuitry that is implemented in connection with processing and control circuits which are generally identified at 912. Although not shown, device 900 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 900 also includes computer-readable media 914, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 900 can also include a mass storage media device 916.

Computer-readable media 914 provides data storage mechanisms to store the device data 904, as well as various device applications 918 and any other types of information and/or data related to operational aspects of device 900. For example, an operating system 920 can be maintained as a computer application with the computer-readable media 914 and executed on processors 910. The device applications 918 can include a device manager (e.g., a control application, software application, signal processing and control module, code that is native to a particular device, a hardware abstraction layer for a particular device, etc.). The device applications 918 also include any system components or modules to implement embodiments of the techniques described herein. In this example, the device applications 918 include an interface application 922 and an input/output module 924 that are shown as software modules and/or computer applications. The input/output module 924 is representative of software that is used to provide an interface with a device configured to capture inputs, such as a touchscreen, track pad, camera, microphone, and so on. Alternatively or in addition, the interface application 922 and the input/output module 924 can be implemented as hardware, software, firmware, or any combination thereof. Additionally, the input/output module 924 may be configured to support multiple input devices, such as separate devices to capture visual and audio inputs, respectively.

Device 900 also includes an audio and/or video input-output system 926 that provides audio data to an audio system 928 and/or provides video data to a display system 930. The audio system 928 and/or the display system 930 can include any devices that process, display, and/or otherwise render audio, video, and image data. Video signals and audio signals can be communicated from device 900 to an audio device and/or to a display device via an RF (radio frequency) link, S-video link, composite video link, component video link, DVI (digital video interface), analog audio connection, or other similar communication link. In an embodiment, the audio system 928 and/or the display system 930 are implemented as external components to device 900. Alternatively, the audio system 928 and/or the display system 930 are implemented as integrated components of example device 900.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented by a computing device, the method comprising:
displaying a user interface having selectable representations of content sources, at least one of which is available via a network;
responsive to selection of one or more of the content sources via the user interface, displaying representations of content in the user interface using metadata obtained from the selected one or more content sources, the representations arranged according to a hierarchy used at a respective said content source to arrange access to the content;
responsive to selection of one or more of the representations via the user interface; obtaining the content that corresponds to the selected representations; and
displaying the obtained content in the user interface.

2. A method as described in claim 1, wherein the displaying of the representations is performed to populate the user interface with representations obtained from the content source in response to navigation through the user interface.

3. A method as described in claim 1, wherein at least one of the content sources is configured as storage that is local to the computing device.

4. A method as described in claim 1, wherein at least one of the content sources is a social network service.

5. A method as described in claim 1, wherein the metadata is obtained from a network service via a user account by using credentials of a user.

6. A method as described in claim 1, wherein the content sources involve either a device or a user account associated with a single user.

7. A method as described in claim 1, wherein the user interface involved in the displaying of the representations includes functionality to search the metadata to locate a particular item of the content without obtaining the item of content at the computing device.

8. A method as described in claim 1, wherein the representations are obtained from a plurality of content sources to provide an aggregated view of the content.

9. A method as described in claim 1, wherein the displaying of the representations provides a first view and further comprising responsive to receipt of an input to switch from the first view to a second view, obtaining additional metadata to represent the content.

10. A method as described in claim 9, wherein the representations in the first view are configured as thumbnails and representations in the second view are configured as larger representations of the content than the thumbnails.

11. A method implemented by one or more computing devices, the method comprising:
obtaining metadata, from a plurality of content sources, that describes content and how content is arranged in a hierarchy at a respective said content source;
constructing an aggregate view of the plurality of content using the metadata as corresponding to the hierarchies at the respective said content sources; and
displaying the aggregate view in a user interface as having representations of the plurality of content accessible via the hierarchies, at least one said representation being selectable to cause corresponding said content to be retrieved via a network connection from a corresponding said source.

12. A method as described in claim 11, wherein the obtaining and constructing is performed dynamically responsive to navigation through the aggregate view.

13. A method as described in claim 11, wherein at least one of the content sources is configured as storage that is local to the computing device and another one of the content sources is accessible via the network connection using credentials of a user.

14. A method as described in claim 13, wherein the other one of the content sources is a social network service.

15. A method as described in claim 13, wherein the user interface includes functionality to search the metadata to locate a particular item of the content without obtaining the item of content at the computing device.

16. A method as described in claim 11, wherein the obtaining is performed to cache the metadata locally at the one or more computing devices to support offline access.

17. A method implemented by one or more computing devices, the method comprising:
displaying representations of images or videos in a user interface formed from metadata obtained from a plurality of content sources in which at least one said content source is local to the computing device and another said content source is accessible remotely to the computing device via a network;
indicating which of the representations are of images or videos that have been duplicated in the plurality of content sources; and
outputting one or more options to address the duplication of the images or videos.

18. A method as described in claim 17, wherein the user interface includes functionality to search the metadata to locate a particular item of the content without obtaining the item of content at the computing device.

19. A method as described in claim 17, wherein the displaying, the indicating, and the outputting are performed by the one or more computing devices without downloading the content itself.

20. A method as described in claim 17, wherein the displaying is performed using metadata obtained dynamically responsive to navigate through the user interface populate the user interface.
